(19) United States
(12) Patent Application Publication
(10) Pub. No.: US 2023/0189760 A1
(43) Pub. Date: Jun. 22, 2023

(54) TOY FOR PET DOGS

(71) Applicant: Jinye CHENG, Lu'an (CN)

(72) Inventor: Jinye CHENG, Lu'an (CN)

(21) Appl. No.: 17/579,618

(22) Filed: Jan. 20, 2022

(30) Foreign Application Priority Data
Dec. 20, 2021 (CN) 202123232590.5

(51) Int. Cl. A01K 15/02; H04R 1/02; H04R 3/00

(52) U.S. Cl. CPC A01K 15/025; H04R 1/028; H04R 3/00

(57) ABSTRACT

A toy for pet dogs is provided and includes a toy body, which is a doll imitating a pet dog appearance, a hip of the toy body is provided with an accommodating chamber, and the accommodating chamber is provided with an anti-slip neck, a silicone body is internally provided with a channel and a simulation port connected with the channel; the silicone body is inserted into the accommodating chamber and the simulation port is exposed from outside, an end of the silicone body around the simulation port forms a funnel-shaped groove, and the silicone body is provided with a snapping groove matched with the anti-slip neck. The toy for pet dogs is made as the toy of the pet dog in estrus, it is easy to install, change and wash.

### TECHNICAL FIELD

The disclosure relates to the technical field of pet supplies, and more particularly to a toy for pet dogs.

### BACKGROUND

With the acceleration of the urbanization and the continuous improvement of people's living standards, the breeding of pets is more and more extensive, among which the breeding of pet dogs is the most common. As a good friend of human beings, the pet dogs have become the sustenance of leisure and emotional ways in people's life. The raising of family pets has gradually become a new way of urban life and entertainment, and there are a wide range of pet products suitable for the pet dogs.

Although there are many products to meet the needs of the pet dogs, none of them can meet the needs of the pet dogs in estrus. In particular, when the artificial sperm extraction method resisted by the pet dogs is excluded, a toy for pet dogs that can meet use needs of the pet dogs in estrus is needed.

### SUMMARY

For the lack of the pet toys to meet the needs of the pet dogs in estrus. The disclosure provides a toy for pet dogs to meet the use needs of the pet dogs in estrus.

In order to achieve the above objective, the disclosure provides the technical scheme:

an embodiment of the disclosure provides a toy for pet dogs including:

a toy body, the toy body is a doll imitating an appearance of a pet dog, a hip of the toy body is provided with an accommodating chamber (also referred to receiving chamber), and an opening position of the accommodating chamber is provided with an anti-slip neck (also referred to as anti-slip protrusion for opening reduction); and

a silicone body, the silicone body is internally provided with a channel, and an end of the silicone body is provided with a simulation port connected with the channel; the silicone body is inserted into the accommodating chamber and the simulation port is exposed from outside, an end of the silicone body around the simulation port forms a groove with a funnel-shaped structure (also referred to as funnel-shaped groove), and the silicone body is provided with a snapping groove matched with the anti-slip neck.

When making the toy body imitate the appearance of the pet dog, the toy body is made as the toy of the pet dog in estrus according to the ratio of 1:1 with the pet dog, when the silicone body is putted into the accommodating chamber of the hip of the toy body, it can ensure that the silicone body and the toy body will not slip through the anti-slip neck; the toy body is used to imitate the pet dog as the toy of the pet dog in estrus, the silicone body is easy to install, change and wash. Moreover, the exposed part of the silicone body at the tail of the toy body adopts the design of imitating funnel structure, it is convenient for the pet dogs in use, the pet dog pokes into the surrounding area of the simulation port when in use and slide into the simulation port smoothly.

In an embodiment, the toy body includes an injection molded housing and a plush cloth attached to an outer surface of the injection molded housing, during injection molding, the injection molded housing forms the accommodating chamber used to hold the silicone body and a component compartment, the component compartment is disposed in an abdomen of the toy body, and the component compartment is internally provided with a battery, the toy body and the silicone body are assembled to imitate the appearance of the pet dog.

In an embodiment, the toy body is further provided with a circuit board, the circuit board is electrically connected with the battery in the component compartment; and the toy body is further provided with a speaker, the speaker is disposed in the component compartment and connected with the circuit board. The speaker in the toy body is used to imitate the sound interested by the pet dog, and further stimulate the pet dog's desire to interact with the toy of the pet dog.

In an embodiment, the toy body is electrically connected with the silicone body, the accommodating chamber of the toy body is internally provided with a magnetic attraction socket, an end of the silicone body facing away from the simulation port is provided with a magnetic attraction connector, when the silicone body is disposed in the accommodating chamber, the magnetic attraction socket is connected with magnetic attraction connector, thereby achieving the electrical connection between electrical elements disposed in the silicone body and the circuit board.

In an embodiment, two internal sides of the simulation port of the silicone body are provided with touch switches respectively connected in series between the battery and the circuit board, when the pet dog uses the silicone body, and the simulation port is expanded, the touch switches are triggered to close, so that making the circuit board be connected to the battery to start the speaker and the electrical components in the silicone body to energized work.

In an embodiment, the silicone body is internally provided with a silicone sleeve, the silicone sleeve is disposed in the silicone body located around the channel, the silicone sleeve is embedded with heating rods, the heating rods are electrically connected with the circuit board, when the touch switches are triggered to close, the circuit board control the heating rods to heat, so that the silicone body can imitate the temperature of the pet dog.

In an embodiment, the silicone body is further internally provided with a vibration motor connected with the circuit board, the vibration motor is disposed in the silicone body, when the touch switches are triggered to close, controlling the vibration motor to vibrate, which makes the silicone body imitate the real sensuality of the pet dog, achieves the effect of imitating the pet dog, improves the imitating degree, it is conducive to cultivate the relationship between the pet dog and the toy of the pet dogs, and is more conducive to the closeness of the pet dogs.

In an embodiment, four legs of the toy body are respectively provided with foot fixing members, each of the foot fixing members includes a suction cup or a base connected by a bolt; the bolts are screwed in the bolt holes on the four legs of the toy body, which is convenient to fine tune the height of the toy body by screwing, and the suction cup is adsorbed on the ground to increase the placement stability of the toy body.

Compared with the prior art, the beneficial effects of the disclosure are:

the toy for pet dogs provided in the embodiments of the disclosure, compared with the conventional pet dog toy, the anti-slip neck of the accommodating chamber is cleverly used to fix the silicone body, the simulation port of the silicone body is exposed outside, the groove with the funnel-shaped structure is formed around the simulation port and located at the exposed part of the simulation port, that is the exposed part of the silicone body at the tail of the toy body adopts the design of imitating funnel structure, it is convenient for the pet dogs in use, the pet dog pokes into the surrounding area of the simulation port when in use and slide into the simulation port smoothly, therefore, the exposed part of the silicone body at the tail of the toy body adopts the design of imitating funnel structure, when the pet dog uses the toy for pet dogs, the pet dog pokes into the surrounding area of the simulation port and can slide into the simulation port smoothly and enter the channel; the silicone body imitates the sensuality feeling and appearance of the pet dog to achieve the effect of imitating the pet dog, the imitating degree is improved, it is conducive to the using of the toy during the estrus period of the pet dogs, and is more conducive to getting closer to and cultivating emotion with the pet dogs. The installation and washing of the silicone body are convenient and fast.

### BRIEF DESCRIPTION OF DRAWINGS

In order to more clearly explain the technical scheme of the embodiments of the disclosure, the following will briefly introduce the attached drawings needed to be used in the embodiments or the prior art description. Obviously, the attached drawings in the following description are only some embodiments of the disclosure.

FIG. 1 is a schematic structural diagram of a toy for pet dogs according to an embodiment of the disclosure.

FIG. 2 is a schematic structural diagram of a toy body of the toy for pet dogs according to an embodiment of the disclosure.

FIG. 3 is a schematic structural diagram of a silicone body of the toy for pet dogs according to an embodiment of the disclosure.

FIG. 4 is a schematic structural diagram of a hip of the toy for pet dogs according to an embodiment of the disclosure.

FIG. 5 is a schematic structural diagram of a side of the toy for pet dogs according to an embodiment of the disclosure.

FIG. 6 is a schematic sectional diagram of a partial structure of the toy for pet dogs according to an embodiment of the disclosure.

FIG. 7 is a schematic structural diagram of a bottom of the toy for pet dogs according to an embodiment of the disclosure.

Description of reference numerals:

1—toy body; 11—injection molded housing; 12—accommodating chamber; 121—anti-slip neck; 13—magnetic attraction socket; 14—component compartment; 141—battery; 142—circuit board; 15—speaker; 2—silicone body; 21—artificial silica opening; 22—channel; 23—bucking groove; 24—magnetic attraction connector; 25—touch switch; 26—silicone sleeve; 27—heating rod; 28—vibration motor; 3—fixed foot position.

### DETAILED DESCRIPTION OF EMBODIMENTS

In order to make the purpose, technical scheme and advantages of the disclosure clearer, the disclosure is further described in detail below in combination with the attached drawings and embodiments. It should be understood that the specific embodiments described herein are only used to explain the disclosure and are not used to limit the disclosure.

The applicant found that at present, there are a wide range of pet products suitable for pet dogs, and there are countless products to meet the needs of the pet dogs, but none of them can meet the needs of the pet dogs in estrus.

In order to solve the above problems, the embodiment of the disclosure provides a toy for pet dogs, the toy for pet dogs is designed by imitating the pet dogs, when making the toy imitating the appearance of the pet dog, the toy body is made as the toy of the pet dog in estrus according to the ratio of 1:1 with the pet dog; when the silicone body is putted into the accommodating chamber of the hip of the toy body, it can ensure that the silicone body and the toy body will not slip through the anti-slip neck; the toy body is used to imitate the pet dog as the toy of the pet dog in estrus, the silicone body is easy to install, change and wash.

The technical scheme of the disclosure is further described below in combination with the attached drawings and through specific embodiments.

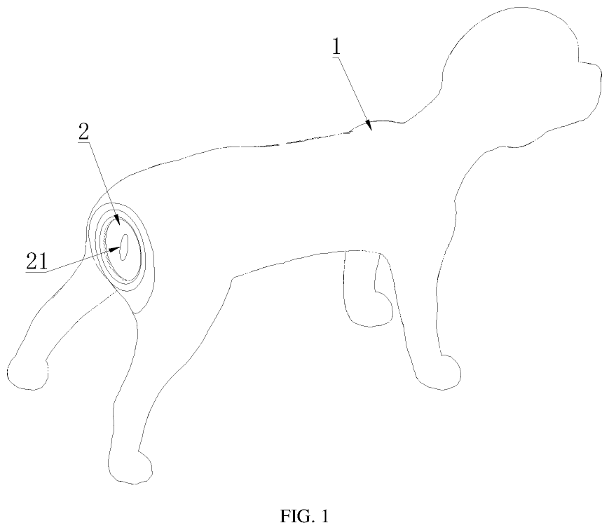

FIG. 1 is a schematic structural diagram of the toy for pet dogs according to the embodiment of the disclosure.

As shown in FIG. 1, in a first embodiment of the disclosure, the toy for pet dogs includes a toy body 1 and a silicone body 2.

In the first embodiment, the toy body 1 is a doll imitating an appearance of a pet dog, when making the toy body imitate the appearance of the pet dog, the toy body 1 is made as the toy of the pet dog in estrus according to the ratio of 1:1 with the pet dog; when the silicone body 2 is putted into the hip of the toy body 1, the toy body 1 is used to imitate the pet dog as the toy of the pet dog in estrus, the silicone body 2 is easy to install, change and wash.

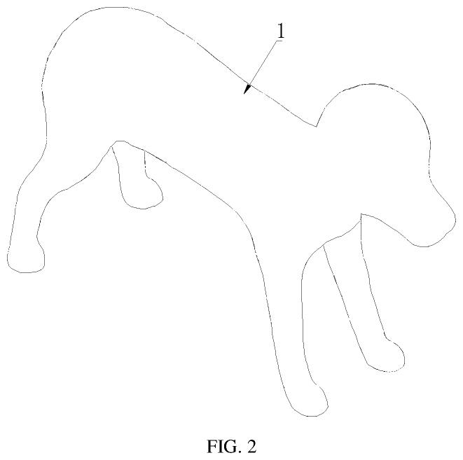

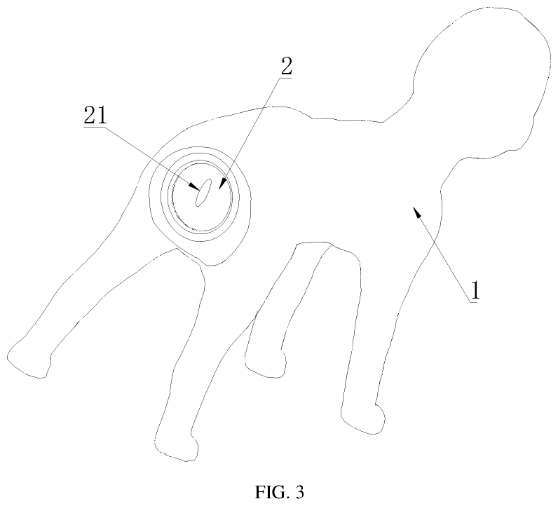

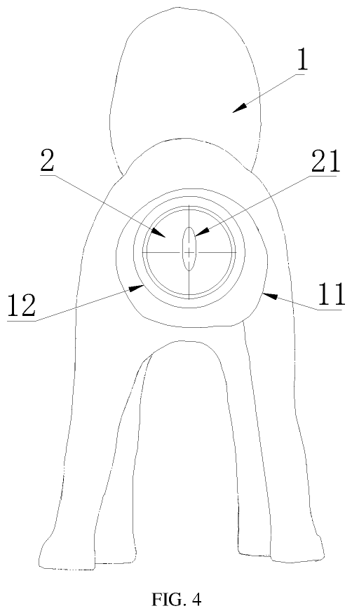

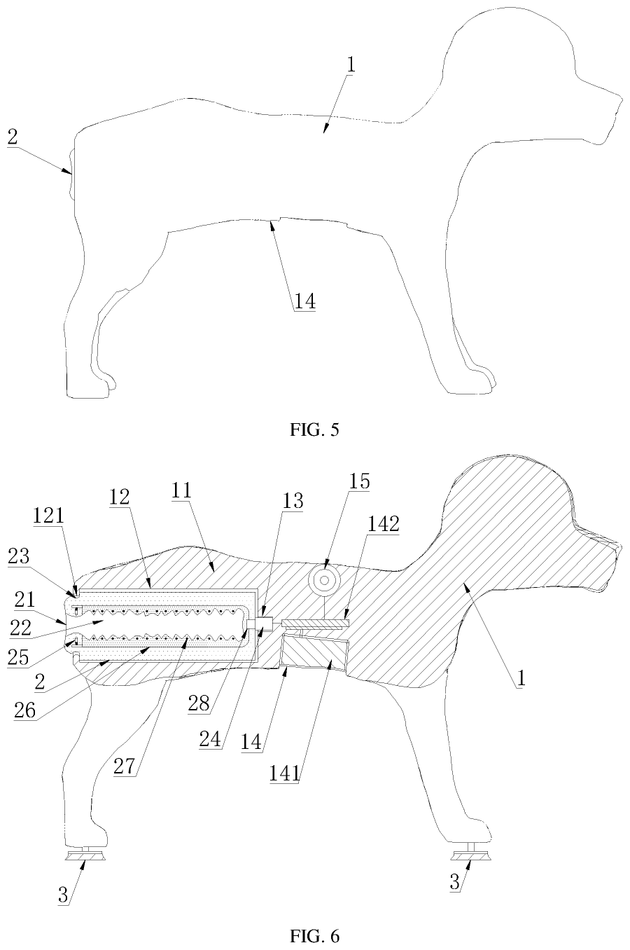

As shown in FIG.1 to FIG. 6, a hip of the toy body 1 is provided with an accommodating chamber 12, and an opening position of the accommodating chamber 12 is provided with an anti-slip neck 121. The silicone body 2 is internally provided with a channel 22, and an end of the silicone body 2 is provided with a simulation port 21 connected with the channel 22, the silicone body 2 is provided with a snapping groove 23 matched with the anti-slip neck 121. The silicone body 2 is installed into the accommodating chamber 12 of the hip of the toy body 1, which can ensure that the silicone body 2 and the toy body 1 are buckled and do not slip through the anti-slip neck 121.

The silicone body 2 is inserted into the accommodating chamber 12 and the simulation port 21 is exposed outside (also referred to as exposed from the accommodating chamber), an end of the silicone body 2 around the simulation port 21 forms a funnel-shaped groove. In this embodiment, the exposed part of the silicone body 2 at the tail of the toy body 1 adopts the design of imitating the funnel structure, it is convenient for the pet dogs in use, the pet dog pokes into the surrounding area of the simulation port 21 when in use and slide into the simulation port 21 smoothly, therefore, the exposed part of the silicone body 2 at the tail of the toy body 1 adopts the design of imitating the funnel structure, when the pet dog uses the toy for pet dogs, the pet dog poke into the surrounding area of the simulation port 21 and can slide into the simulation port smoothly.

As shown in FIG.6, the abdomen of the toy body 1 is internally provided with a component compartment 14, the component compartment 14 is internally provided with a battery 141. Specifically, the toy body 1 includes an injection molded housing 11 and a plush cloth attached to an outer surface of the injection molded housing 11, during injection molding, the injection molded housing 11 forms the accommodating chamber 12 used to hold the silicone body 2 and forms the component compartment 14 used to hold the battery 141.

In an illustrated embodiment of the disclosure, as shown in FIG.6, the injection molded housing 11 is composed of left and right parts symmetrical along the middle, which are connected by screws to form a complete toy body 1 of the toy for pet dogs. In order to increase the imitating effect, the plush cloth is pasted on the outside of the toy body 1, so that the appearance of the toy for pet dogs is closer to the real pet dog.

The injection molded housing 11 forms the accommodating chamber 12 used to hold the silicone body 2 and the component compartment 14 used to hold the battery 141 during injection molding, which is convenient to install the toy body 1 and the silica gel boy 2 to imitate the appearance of the pet dogs.

In an illustrated embodiment, the toy body 1 is further provided with a circuit board 142, the circuit board 142 is electrically connected with the battery 141 in the component compartment 14, and the component compartment 14 of the toy body 1 is further provided with a speaker 15, the speaker 15 is connected with the circuit board 142. The speaker 15 in the toy body 1 is used to imitate the sound interested by the pet dog, and further stimulate the pet dog's desire to interact with the toy of the pet dog.

In an illustrated embodiment, the toy body 1 is electrically connected with the silicone body 2, the accommodating chamber 12 of the toy body 1 is provided with a magnetic attraction socket 13, an end of the silicone body 2 facing away from the simulation port 21 is provided with a magnetic attraction connector 24, when the silicone body 2 is disposed in accommodating chamber 12, the magnetic attraction connector 24 is connected with magnetic attraction socket 13, thereby achieving the electrical connection between electrical elements disposed in the silicone body 1 and the circuit board 142.

In this embodiment, the toy body 1 and the silicone body 2 are electrically connected through the magnetic attraction connector 24 and the magnetic attraction socket 13. After the silicone body 2 is disposed in the accommodating chamber 12, the magnetic attraction connector 24 on the silicone body 2 is inserted into the magnetic attraction socket 13 to realize the electrical connection while adsorbing and docking.

In an illustrated embodiment, two internal sides of the simulation port 21 of the silicone body 2 are provided with touch switches 25 respectively connected in series with the battery 141 and the circuit board 142, when the pet dog uses the silicone body 2, and the simulation port 21 is expanded, the touch switches 25 are triggered to close, so that making the circuit board 142 be connected to the battery 141 to start the speaker 14 and the electrical components in the silicone body 2 to energized work.

In an illustrated embodiment, the silicone body 2 is internally provided with a silicone sleeve 26, the silicone sleeve 26 is disposed in the silicone body 2 located around the channel 22, the silicone sleeve 26 is embedded with heating rods 27, the heating rods 27 are electrically connected with the circuit board 142, when the touch switches 25 are triggered to close, the circuit board 142 controls the heating rods 27 to heat, so that the silicone body 2 can imitate the temperature of the pet dog.

In an illustrated embodiment, the silicone body 2 is further internally provided with a vibration motor 28 connected with the circuit board 142, the vibration motor 28 is disposed in the silicone body 2, when the touch switches 25 are triggered to close, the circuit board 142 controls the vibration motor 28 to vibrate, which makes the silicone body 2 imitate the real sensuality of the pet dog, achieves the effect of imitating the pet dog, improves the imitating degree, it is conducive to cultivate the relationship between the pet dog and the toy of the pet dogs, and is more conducive to the closeness of the pet dogs.

When the pet dog uses the toy, the exposed part of the silicone body 2 at the tail of the toy body 1 adopts the design of imitating funnel structure. When the dog is in use, the dog pokes into the surrounding area of the simulation port 21 and can slide into the opening smoothly. when sliding into the opening, the touch switches 25 are triggered to close, at this time, the circuit board 142 connects the battery 141 and starts the speaker 15, the heating rod 27 and the vibration motor 28 to imitate the sound, temperature and vibration of the real dog to meet the needs of the pet dog in estrus.

The toy for pet dogs of the disclosure, compared with the conventional pet dog toy, the anti-slip neck 121 of the accommodating chamber 12 is cleverly used to fix the silicone body 2, the simulation port 21 of the silicone body 2 is exposed outside, the funnel-shaped groove is formed around the simulation port 21, when the dog is in use, the dog pokes into the surrounding area of the simulation port, and can slide into the simulation port 21 smoothly and enter the channel 22.

The silicone body 2 imitates the sensuality feeling and appearance of the pet dog to achieve the effect of imitating the pet dog, the imitating degree is improved, it is conducive to the using of the toy during the estrus period of the pet dogs, and is more conducive to getting closer to and cultivating emotion with the pet dogs. The installation and washing of the silicone body 2 are convenient and fast.

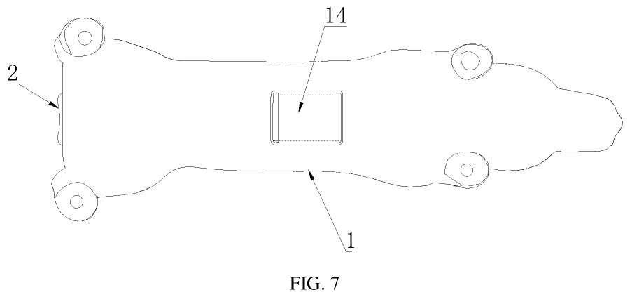

In an illustrated embodiment, as shown in FIG.6 and FIG.7, four legs of the toy body 1 are respectively provided with foot fixing members 3, each of the foot fixing members 3 includes a suction cup or a base connected by a bolt (also referred to as bolt-connected suction cup or bolt-connected base); the bolts are screwed in the bolt holes on the four legs of the toy body 1, which is convenient to fine tune the height of the toy body 1 by screwing, and the suction cup is adsorbed on the ground to increase the placement stability of the toy body 1.

When adjusting, the stability is increased through the suction plate or the base fixing mode, and it is not easy to slide or dump when the pet dog is used, or the height of the toy can be adjusted before using, so that the pet dog with different body height can be used.

The above description is only the exemplary embodiments of the disclosure, but the protection scope of the disclosure is not limited to this. Any modification, equivalent replacement and improvement made within the spirit and principles of the disclosure shall be included in the protection scope of the disclosure.

What is claimed is:

1. A toy for pet dogs, comprising:
a toy body (1), wherein the toy body is a doll imitating an appearance of a pet dog, a hip of the toy body (1) is provided with an accommodating chamber (12), and an opening position of the accommodating chamber (12) is provided with an anti-slip neck (121); and
a silicone body (2), wherein the silicone body (2) is internally provided with a channel (22), and an end surface of the silicone body (2) is provided with a simulation port (21) connected with the channel (22), the silicone body (2) is inserted into the accommodating chamber (12) and the simulation port (21) is exposed from the accommodating chamber (12), an end of the silicone body (2) around the simulation port (21) forms a funnel-shaped groove, and the silicone body (2) is provided with a snapping groove (23) matched with the anti-slip neck (121).

2. The toy for pet dogs according to claim 1, wherein the toy body (1) comprises an injection molded housing (11) and a plush cloth attached to an outer surface of the injection molded housing (11), the injection molded housing (11) is provided with the accommodating chamber (12) used to hold the silicone body (2) and a component compartment (14) during injection molding, the component compartment (14) is disposed in an abdomen of the toy body (1), and the component compartment (14) is internally provided with a battery (141).

3. The toy for pet dogs according to claim 2, wherein the toy for pet dogs further comprises:
a circuit board (142), disposed in the toy body (1) and electrically connected with the battery (141) in the component compartment (14); and
a speaker (15), disposed in the component compartment (14) of the toy body (1) and connected with the circuit board (142).

4. The toy for pet dogs according to claim 3, wherein the toy body (1) is electrically connected with the silicone body (2), and the toy for pet dogs further comprises:
a magnetic attraction socket (13), disposed in the accommodating chamber (12) for the toy body (1); and
a magnetic attraction connector (24), disposed in an end of the silicone body (2) facing away from the simulation port (21) and used for connecting the magnetic attraction socket (13).

5. The toy for pet dogs according to claim 4, wherein the toy for pet dogs further comprises:
touch switches (25), disposed in two internal sides of the simulation port (21) of the silicone body (2) respectively and connected in series between the battery (141) and the circuit board (142).

6. The toy for pet dogs according to claim 5, wherein the toy for pet dogs further comprises:
a silicone sleeve (26), disposed in the silicone body (2) located around the channel (22); and
heating rods (27), embedded in the silicone sleeve (26) and electrically connected with the circuit board (142).

7. The toy for pet dogs according to claim 6, wherein the toy for pet dogs further comprises:
a vibration motor (28), disposed in the silicone body (2) and connected with the circuit board (142).

8. The toy for pet dogs according to claim 6, wherein the toy for pet dogs further comprises:
foot fixing members (3), disposed on four legs of the toy body (1) respectively, wherein each of the foot fixing members (3) comprises a bolt-connected suction cup.
